(19) United States
(12) Patent Application Publication
(10) Pub. No.: US 2011/0002724 A1
(43) Pub. Date: Jan. 6, 2011

(54) Pillow Keycap for a Keyboard

(75) Inventors: Sylvain Sauvage, La Tour-de-Peilz (CH); Cathal Loughnane, Bray County Wicklow (IE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Logitech Europe S.A., Romanel-sur-Morges (CH)

(21) Appl. No.: 12/651,931

(22) Filed: Jan. 4, 2010

Related U.S. Application Data
(60) Provisional application No. 61/222,421, filed on Jul. 1, 2009.

(51) Int. Cl. B41J 5/00

(52) U.S. Cl. 400/495

(57) ABSTRACT

A keyboard includes a base having sets of mounts formed thereon. The keyboard also includes a set of keycaps. Each keycap includes a key top and a support mechanism, which is coupled to the key top and coupled to an associated one of the sets of mounts. The support is configured to lower and raise the key top. Each of the key tops includes a convex-rounded edge surrounding a concave-rounded base. A radius of curvature of the convex-rounded edge is approximately 1.0 to 3.0 millimeters, and a radius of curvature of the concave-rounded base is approximately 32 to 33 millimeters. The keyboard further includes a control circuit coupled to the base and configured to detect downward movement of the keycaps and send a transmission signal to a computer wherein the transmission signal includes information for one of the keycaps downward movement.

### CROSS REFERENCE TO RELATED APPLICATIONS

This application claims the benefit of, and priority to, U.S. Provisional Patent Application No. 61/222,421, filed Jul. 1, 2009, titled “PILLOW KEYCAP FOR A KEYBOARD,” of Sylvain Sauvage, et al, and is incorporated by reference herein in its entirety for all purposes.

### BACKGROUND OF THE INVENTION

The present invention relates to keycaps for a computer keyboard. More specifically, the present invention relates to keycaps for a keyboard having spacing between adjacent keycaps of approximately 0.6 millimeters or less.

Keyboards are a primary input device for computer interactions. Keyboards are made for a variety of uses. Standard size keyboards are used with desktop computers and laptop computers. Standard size keyboards typically have a full set of QWERTY keys, a number pad that is separate from the QWERTY keys, and various function keys. Various smaller keyboards (referred to as mobile keyboards) that are configured for use with mobile devices (e.g., cellular telephones, personal digital assistants, etc.) might have a number pad, or a set of QWERTY keys that also functions as a number pad with the use of a shift key or the like. These mobile keyboards have relatively small keycaps, and are not typically designed for typing for an extended period of time. The keycaps of mobile keyboards are too close together and too small to permit typing for an extended period of time without frustration for locating the keys and/or discomfort. These mobile keyboards typically have relatively small keycaps, which are positioned relatively close to each other (e.g., less than 0.5 millimeters). The keycaps for mobile keyboards have a relatively small downward and upward travel (e.g., 0.5-1.0 millimeters), which in-turn provides that lateral movement of the keycaps is relatively small. The relatively small lateral movement of these keycaps provides that the lateral spacing between keys may be relatively small (e.g., 0.5 millimeters).

Downward and upward travel of traditional keycaps for standard size keyboards is larger than the downward and upward travel of the keycaps of mobile keyboards. The downward and upward travel for traditional keycaps of standard keyboards is approximately 2.5-3.5 millimeters. The relatively large downward and upward travel of the keycaps for standard sized keyboards introduces relatively large lateral movement such that the keycaps are placed relatively far apart (e.g., 1 millimeter or greater). The relatively large spacing between the keycaps provides that the keycaps will not contact each other when being pressed downward by a user. Additionally, traditional keycaps for standard sized keyboards have sharp edges at the tops of the keycaps (see FIG. 2A) where the sharp edges surround the portion of the keycaps that a user's fingers press against during use. The sides of the keycaps that extend from the sharp edge are traditionally slanted downward and out to give greater spacing between a user's fingers on the tops of the keycaps.

Additional problems exist with traditional keyboards, such as the shape of the keys. The key tops of traditional keycaps are generally semi-cylindrical. That is, each key top has left and right sides, which rise from the center of the key top, whereas the front to back sides do not rise from the center of the key top. That is, from the front side to the back side, the shape of the key top is straight. Further, the semi-cylindrical shape of these key tops typically has a relatively large radius of curvature, which does not compliment the shape of many user's finger tips. Therefore, these semi-cylindrical key tops are not efficient at guiding a user's fingers to the center of the key tops.

Keyboard manufacturers continue to strive to design and manufacture keycaps for standard sized keyboards where the keycaps provide greater comfort for use than the traditional keycaps described above. Embodiments of the present invention provide keycaps for standard sized keyboard where the keycaps are spaced closer together than traditional keycaps and have key tops without complex-smooth shapes to improve the comfortable use of the keycaps. Embodiments of the present invention further provide for placing the keycaps relatively close (e.g., 0.65 millimeters apart) so that the keycaps may be made relatively large (e.g., 18 millimeters wide by 18 millimeters long) thereby giving a user's fingers a larger surface area to press on. Further, as the keycaps are relatively large it becomes practical to provide complex-rounded shapes on the tops of the keycaps thereby further adding comfort to a user's fingers tips.

### BRIEF SUMMARY OF THE INVENTION

The present invention provides keycaps for a computer keyboard. More specifically, the present invention provides keycaps for a keyboard having spacings between adjacent keycaps of approximately 0.6 millimeters or less.

According to one embodiment of the present invention, a keyboard includes a base having sets of mounts formed thereon. The keyboard further includes a set of keycaps. Each keycap includes a key top and a support mechanism, which is coupled to the key top and coupled to an associated one of the sets of mounts. The support is configured to lower and raise the key top. Each of the key tops includes a convex-rounded edge surrounding a concave-rounded base. A radius of curvature of the convex-rounded edge is approximately 1.0 to 3.0 millimeters, and a radius of curvature of the concave-rounded base is approximately 32 to 33 millimeters. The keyboard further includes a control circuit coupled to the base and configured to detect downward movement of the keycaps and send a transmission signal to a computer wherein the transmission signal includes information for one of the keycaps downward movement.

According to a specific embodiment of the keyboard, the convex-rounded edge has semi-circular shape. Opposite edge portions of each of the convex-rounded edges are approximately 13-14 millimeters apart. Additionally, a length of each key top is approximately 18 millimeters, and a width of each key top is approximately 18 millimeters. A distance between adjacent key tops is approximately 0.65 millimeters or less.

According to another specific embodiment of the keyboard, each of the sets of mounts includes first and second mount portions. Each of the support mechanisms includes a first arm coupled to a second arm in a scissor configuration. Each first arm of each support mechanism is rotatably coupled to one of the first mount portions of the set of mounts associated with the support mechanism, and each second arm of each support mechanism is slide coupled to one of the second mount portions of the set of mounts associated with the support mechanism.

According to another specific embodiment of the keyboard, each first arm and each second arm of each support mechanism is rotatably attached to the key top, which is coupled to the support mechanism.

According to one embodiment of the present invention, a keycap for a keyboard includes a key top and a support mechanism. The support mechanism is coupled to the key top and is configured to lower and raise the key top. The key tops includes a convex-rounded edge surrounding a concave-rounded base. A radius of curvature of the convex-rounded edge is approximately 1.0 to 3.0 millimeters, and a radius of curvature of the concave-rounded base is approximately 32 to 33 millimeters.

According to a specific embodiment of the present invention, the support mount includes a first arm rotatably coupled to an underside of the key top, and a second arm rotatably coupled to the underside of the key top. The first arm is configured to slide couple to a base of a keyboard, and the second arm is configured to rotatably couple to a base of a keyboard. the first arm and the second arm are coupled in a scissor configuration.

Embodiment of the present invention provide the benefit of having key tops with concave central portions, which guide a user's finger tips to the center of the key. Further, as the top edges of the key tops are rounded, the key tops provide a smooth surface for a user's finders to press on. The relatively large concave portion (e.g., 13.5 millimeters in length and width) further provide a relatively large pushing surface for a user's fingers to further comfort. These and other advantages will be apparent after reviewing the following portions of the specification and the attached figures.

A better understanding of the nature and advantages of the present invention may be gained with reference to the following detailed description and the accompanying drawings.

### BRIEF DESCRIPTION OF THE DRAWINGS

FIGS. 1A and 1B are simplified side views of a keycap according to one embodiment of the present invention;

FIGS. 2A and 2B are, respectively, simplified top views of a traditional key top and a key top according to one embodiment of the present invention;

FIGS. 3A and 3B are, respectively, simplified side views of a traditional key top and a key top according to one embodiment of the present invention;

FIGS. 4A and 4B are, respectively, additional simplified side view of a traditional key top and a key top according to one embodiment of the present invention;

FIGS. 5A and 5B are, respectively, overall perspective views respectively of key top 210 and key top 110;

FIGS. 6A and 6B are, respectively, simplified top views of a portion of a keyboard having traditional key tops and a portion of a keyboard having keycaps according to an embodiment of the present invention; and

FIG. 7 is a circuit diagram for a circuit which may be included in a keyboard according to one embodiment of the present invention.

### DETAILED DESCRIPTION OF THE INVENTION

The present invention provides keycaps for a computer keyboard. More specifically, the present invention provides keycaps for a keyboard having spacings between adjacent keycaps of approximately 0.6 millimeters or less.

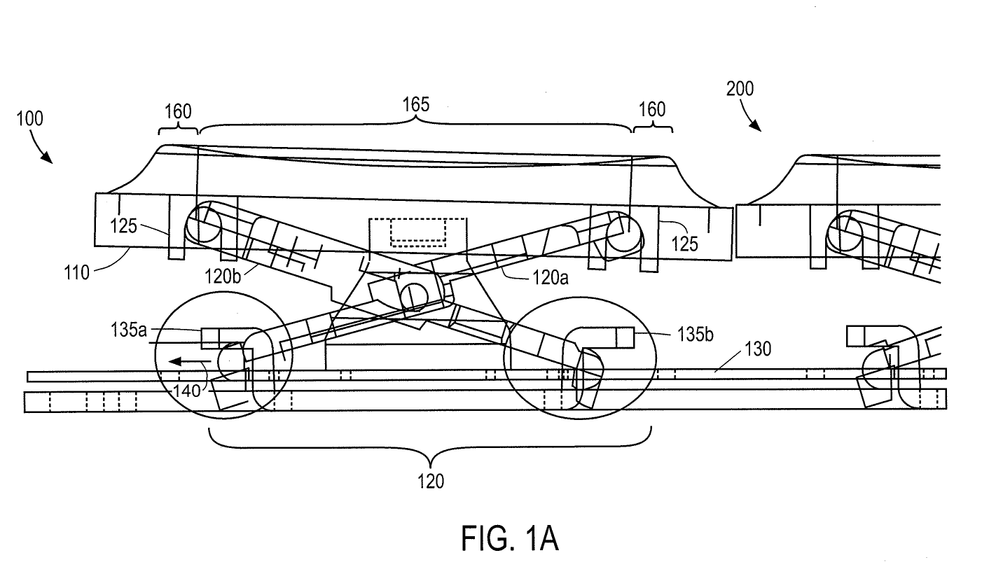

FIGS. 1A and 1B are simplified side views of a keycap 100 according to one embodiment of the present invention. A second keycap 200, adjacent to keycap 100, is partially shown in FIGS. 1A and 1B. Keycaps 100 and 200 are configured for use on a computer keyboard. A computer keyboard, according to one embodiment of the present invention, is a standard-size QWERTY keyboard for use with a computer or is a laptop computer keyboard.

Keycap 100 includes a key top 110 and a support 120 coupled to the bottom of the key top. Support 120 may include a first arm 120a and a second arm 120b coupled approximately at the centers of these arms to provide a hinge coupling of the arms. This hinge coupling is sometimes referred to as a scissor coupling. A top of each arm may be coupled to the key top via a slotted mount 125 formed on the underside of the key top. The slotted mounts permit the tops of the arms to rotate as the key top is moved up or down. A bottom of each arm may be coupled to a base plate 130 of a keyboard. More specifically, the base plate may include mounts 135a and 135b to which the bottoms of arms 120a and 120b are respectively coupled. One of the arms (e.g., arm 120a) may be slide coupled to the mount (e.g., mount 135a). That is, as the key top is pressed downward, the bottom of this arm is free to move laterally along the base plate as indicated by arrow 140. The other arm (e.g., arm 120b) may be similarly slide coupled to the mount (e.g., mount 135b). The other arm (e.g., 120b) may alternatively be rotatably coupled to the other mount (e.g., mount 135b) (e.g., not slide coupled to the mount).

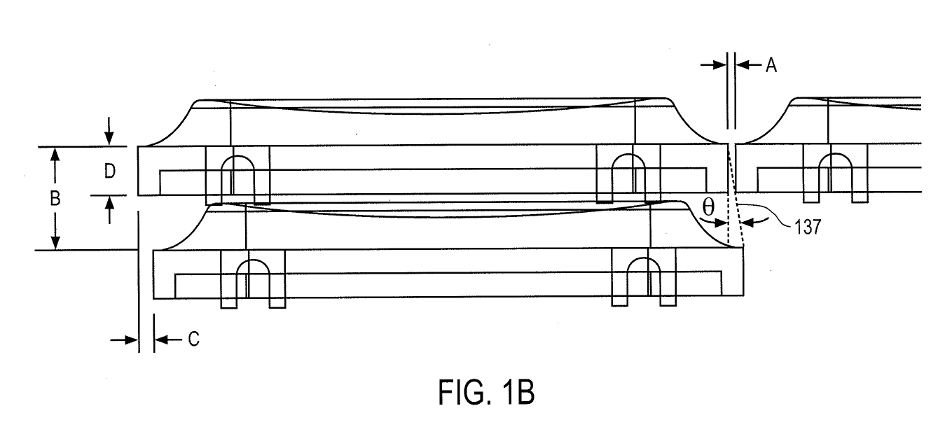

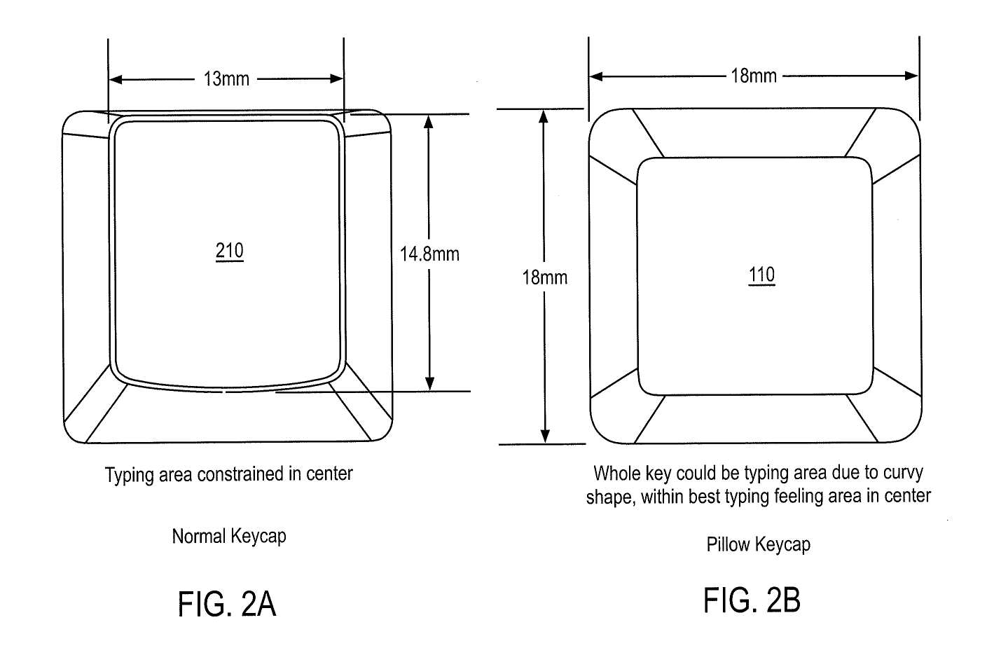

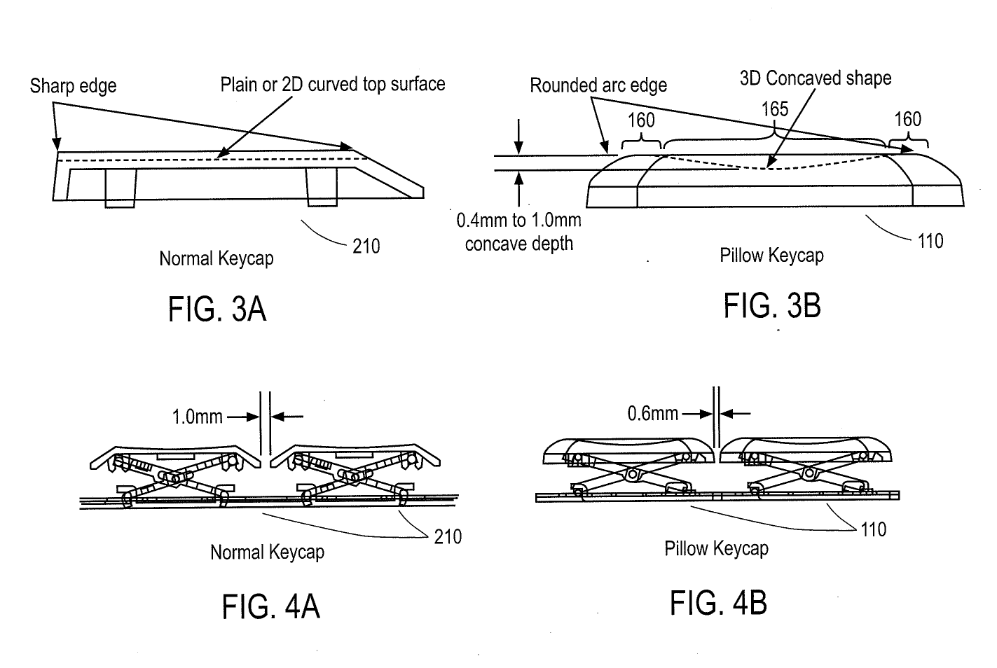

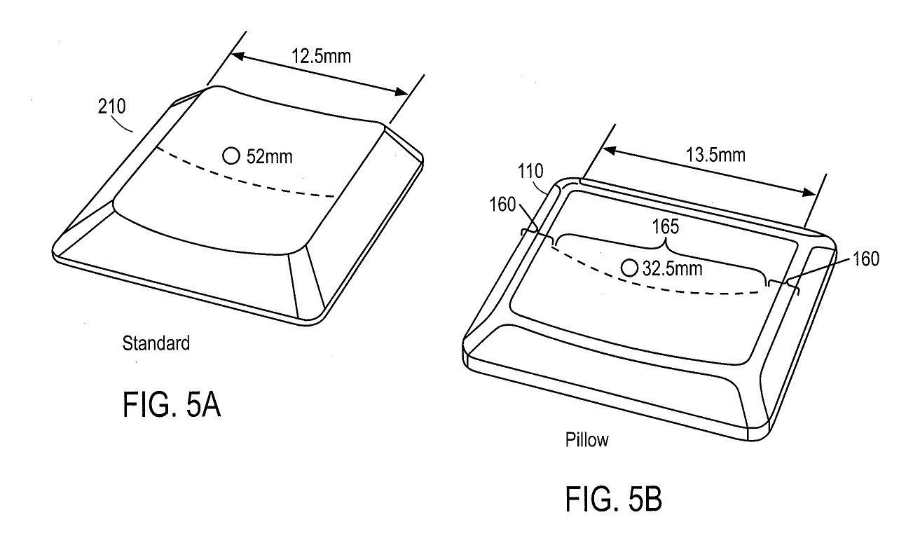

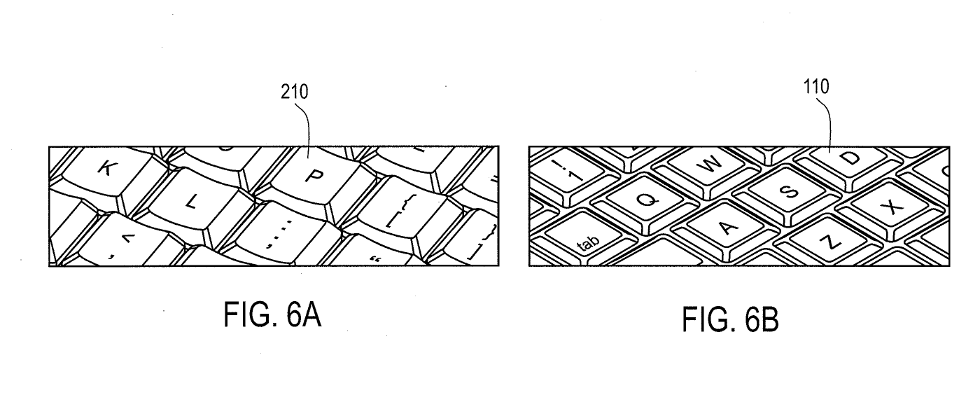

FIGS. 2A and 2B are respective top views of a traditional key top 210 and key top 110 according to one embodiment of the present invention. FIGS. 3A and 3B are respective side views of traditional key top 210 and key top 110 according to one embodiment of the present invention. FIGS. 4A and 4B are respective side views of traditional key top 210 and key top 110 according to one embodiment of the present invention. FIGS. 5A and 5B are overall perspective views respectively of traditional key top 210 and key top 110 according to one embodiment of the present invention. FIGS. 6A and 6B are respective top views of a portion of a keyboard having traditional key tops 210 and a portion of a keyboard having keycaps 100 according to one embodiment of the present invention. According to one embodiment, key top 110 is approximately 18 millimeters long and 18 millimeters wide. Traditional key tops are shorter in both length and width compared to the key top of the present invention. The length and width of traditional key tops are shorter to provide a gap 137 (see FIG. 1B) between adjacent key tops on a traditional key board of about 1 millimeter or greater. This approximately 1 millimeter or greater gap between key tops is used on traditional keyboards because the keycaps move laterally by a relatively large amount when the keycaps are pressed. Keycaps typically have a downward travel of about 2.5 to 3.5 millimeters and have lateral movement such that a 1 millimeter gap or larger is required to inhibit contact between the key tops during downward and upward movement.

Keycaps according to one embodiment of the present invention have relatively small lateral movement during up and down travel so that the spacing between the key tops of these keycaps may be relatively small so that the key tops do not contact one another during up and down travel. According to one embodiment, the relatively small lateral movement of the keycaps of the present invention is provided in part by one of the arms of support 120 being slide coupled to it's associated mount, and the other arm not being rotationally slide coupled to its associated mount, but being rotatably coupled to its associated mount. The rotation coupling compared to the slide coupling has less lateral movement of the keycap as the keycap's key top is moved up and down. Thereby, the relatively tight tolerances (0.65 millimeters or less (e.g., 0.225 millimeters)) may be held between adjacent keycaps. Further, as one arm is slide coupled to its associated mount, and the other arm is rotation coupled to its associated mount, the amount of lateral movement of a keycap may be controlled. For example, the keycap may move laterally by a controlled amount as the keycap moves downward. For example, the keycap may have a relatively small lateral displacement at the top of its downward movement, and may have a relatively large lateral displacement at the bottom of the downward movement. For example, as shown in FIG. 1B, the displacement “C” at the bottom of the downward movement of the keycap may be 0.5 millimeters or less (e.g., 0.48 millimeters). The downward overall travel “B,” as shown in FIG. 1B, of the keycap may be about 3.5 millimeters or less (e.g., about 3.2 millimeters).

According to one embodiment, the gap 137 between keycap 100 and 200 (see FIG. 1B) is approximately 0.65 millimeters or less (e.g., 0.225 millimeters). Typical keycaps on keyboards have a gap of approximately 1.0 millimeters or greater. Reducing the width of the gaps between key tops provides that the key tops may be relatively larger (e.g., 18 mm long×18 mm wide) than traditional key tops. With the key tops being relatively larger than traditional key tops, a relatively large surface area is provided for a user's fingers to strike the keycaps. Larger key tops further provide that key tops may have complex shapes, which add comfort for user's fingertips while pressing the key tops.

According to one embodiment of the present invention, the key tops have a convex-rounded edge 160, which surrounds a concave base 165. Convex-rounded edge 160 is substantially square where the center of the square is approximately centered on the key top. The radius of curvature of convex-rounded edge 160 may be from 1.0 to 3.0 millimeters, and the radius of curvature of the concave base may be about 32-33 millimeters. The curved shape of convex-rounded edge 160 may be semi-circular or have another curve shape. Concave base 165, which is surrounded by convex-rounded edge 160, may have a semi-spherical shape. That is, for each key top, the left side and the right side of the key tops rise upward from the center of the key top to convex-rounded edge 160, and the front side and the back side of the key tops rise upward from the center of the key top to convex-rounded edge 160. The radius of curvature of concave base 165 is relatively small compared to the radius of curvature of traditional cylindrical shaped key tops. The semi-spherical shape of the key tops, and the relatively small radius of curvature of the semi-spherical shape of the key tops forms a well, which is configured to guide a user's fingers to the center of key tops as the key tops are pressed generally downward. Further, because the key top of each keycap is semi-spherical with a relatively small radius of curvature, the shape of the key top compliments that shape of user's “fully” rounded finger tips further guiding the user's fingers to the center of the key tops.

The distance between opposite edge portions (e.g., edge portions 160a and 160b) of convex-rounded edge 160 may be about 13-14 millimeters. The described shape and size of the key tops provides a relatively larger pressing area and a relatively deeper concave base than traditional key tops to more fully cup a user's finger tip as the user presses the key tops. Further, because convex-rounded edge 160 is curved, the user's fingers are not subjected to any sharp edges as the key tops are pressed. Further, as the user's fingers pass over the key tops and press on the key tops, the user's fingers feel a relatively smooth surface, which increased the user's comfortable use of the keycaps and the keyboard. According to one embodiment the height of the key top is 2.5-3.0 millimeters.

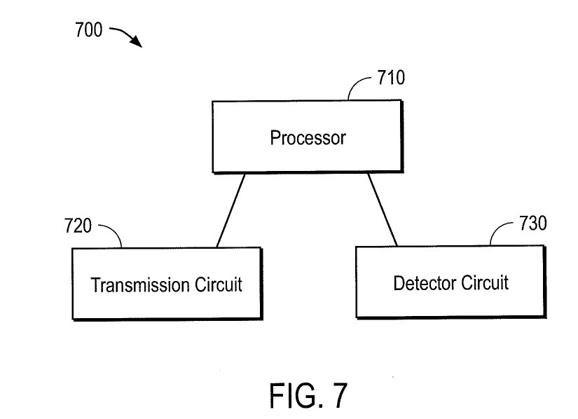

FIG. 7 is a circuit diagram for a control circuit 700, which may be included in a keyboard according to one embodiment of the present invention. Control circuit 700 includes a processor (e.g., a microprocessor) 710, a transmission circuit 720 coupled to the processor, and a set of detection circuits 730 coupled to the processor. Transmission circuit 720 may be configured to receive requests from the processor to send communications to a computer in communication with the keyboard. The transmission circuit may be configured for wire or wireless communication. The transmission circuit under control of the processor may be configured to send information for various keycap press events to a computer. Detection circuit 730 may include a plurality of detectors, where each detector is located adjacent to (e.g., under) a given on of the keycaps and is configured to detect a downward press on the keycap. The detectors may be capacitive sensors, contact sensors or the like. The detectors may be an integral part of a circuit board.

It is to be understood that the examples and embodiments described above are for illustrative purposes only and that various modifications or changes in light thereof will be suggested to persons skilled in the art and are to be included within the spirit and purview of this application and scope of the appended claims. Therefore, the above description should not be understood as limiting the scope of the invention as defined by the claims.

What is claimed is:

1. A keyboard comprising:
a base having sets of mounts formed thereon;
a set of keycaps, wherein:
each keycap includes a key top and a support mechanism, which is coupled to the key top and coupled to an associated one of the sets of mounts, and the support is configured to lower and raise the key top, and
each of the key tops includes a convex-rounded edge surrounding a concave-rounded base,
a radius of curvature of the convex-rounded edge is approximately 1.0 to 3.0 millimeters, and
a radius of curvature of the concave-rounded base is approximately 32 to 33 millimeters; and
a control circuit coupled to the base and configured to detect downward movement of the keycaps and send a transmission signal to a computer wherein the transmission signal includes information for one of the keycaps downward movement.

2. The keyboard of claim 1, wherein the convex-rounded edge has semi-circular shape.

3. The keyboard of claim 1, wherein opposite edge portions of each of the convex-rounded edges are approximately 13-14 millimeters apart.

4. The keyboard of claim 1, wherein a length of each key top is approximately 18 millimeters, and a width of each key top is approximately 18 millimeters.

5. The keyboard of claim 1, wherein a distance between adjacent key tops is approximately 0.65 millimeters or less.

6. The keyboard of claim 5, wherein:
each of the sets of mounts includes first and second mount portions,
each of the support mechanisms includes a first arm coupled to a second arm in a scissor configuration,
each first arm of each support mechanism is rotatably coupled to one of the first mount portions of the set of mounts associated with the support mechanism, and
each second arm of each support mechanism is slide coupled to one of the second mount portions of the set of mounts associated with the support mechanism.

7. The keyboard of claim 6, wherein each first arm and each second arm of each support mechanism is rotatably attached to the key top, which is coupled to the support mechanism.

8. A keycap for a keyboard comprising:
a key top; and
a support mechanism, which is coupled to the key top and is configured to lower and raise the key top, wherein the key tops includes a convex-rounded edge surrounding a concave-rounded base, and wherein a radius of curvature of the convex-rounded edge is approximately 1.0 to 3.0 millimeters, and a radius of curvature of the concave-rounded base is approximately 32 to 33 millimeters.

9. The keycap of claim 8, wherein the support mount includes a first arm rotatably coupled to an underside of the key top, and a second arm rotatably coupled to the underside of the key top.

10. The keycap of claim 9, wherein the first arm is configured to slide couple to a base of a keyboard, and the second arm is configured to rotatably couple to a base of a keyboard.

11. The keycap of claim 9, wherein the first arm and the second arm are coupled in a scissor configuration.
